(19) United States
(12) Patent Application Publication
(10) Pub. No.: US 2013/0081227 A1
(43) Pub. Date: Apr. 4, 2013

(54) DOOR CLOSER

(71) Applicants: Somnath Hensh, West Bengal (IN); Barath C. Ramadas, Pondicherry (IN)

(72) Inventors: Somnath Hensh, West Bengal (IN); Barath C. Ramadas, Pondicherry (IN)

(73) Assignee: INGERSOLL RAND SECURITY TECHNOLOGIES LIMITED, West Midlands (GB)

(21) Appl. No.: 13/638,035

(22) PCT Filed: Mar. 28, 2011
(86) PCT No.: PCT/GB2011/000443

§ 371 Date: Nov. 26, 2012

(30) Foreign Application Priority Data
Mar. 29, 2010 (GB) 1005317.1

(51) Int. Cl. E05F 3/10

(52) U.S. Cl. CPC E05F 3/104
USPC 16/53

(57) ABSTRACT

A door closer comprising a drive spindle which is operably connected to a first spring configured to apply a first closing torque to the drive spindle, wherein the drive spindle is also operably connected to a second spring configured to apply a second closing torque to the drive spindle, wherein the connection between the first spring and the drive spindle is independent from the connection between the second spring and the drive spindle, and wherein variation of the first closing torque as a function of drive spindle orientation is different from variation of the second closing torque as a function of drive spindle orientation.

### CROSS-REFERENCE TO RELATED APPLICATIONS

This application is a national phase application of PCT Application No. PCT/GB2011/000443, filed Mar. 28, 2011, which claims priority to United Kingdom Patent Application No. 1005317.1, filed Mar. 29, 2010, the entire contents of which are both hereby incorporated by reference herein.

### BACKGROUND

The present invention relates to a door closer of the kind that is used to control the movement of a door from an open position to a closed position.

A door closer is conventionally fitted to a door or door frame and typically comprises a mechanism for storing energy such as, for example, a spring. Energy is stored during opening of the door and is released to effect automatic closure of the door. The force which is required in order to effect automatic closure of a door may be significant. Consequently, the energy storage mechanism of the door may be required to store a substantial amount of energy.

### SUMMARY

The torque which is applied by a door closer to close a door is referred to as the closing torque. It is desirable to provide a closing torque which rises when the door approaches a closed position. For example it may be desirable to provide a closing torque which is higher when the door is at angle of between 0° and 10° (relative to the closed position), than when the door is at an angle greater than 10°. This helps to ensure that the door closes and latches properly, something which is particularly pertinent for fire doors. Although known door closers are capable of providing a closing torque which conforms generally with this torque profile, they include a long transition between the relatively high torque and the relatively low torque (the transition may for example be spread over around 20°.

It may be desirable to provide a door closer which provides a shorter transition between a relatively low closing torque and a relatively high closing torque. It may be desirable to provide an improved or alternative door closer.

According to a first aspect of the invention there is provided a door closer comprising a drive spindle which is operably connected to a first spring configured to apply a first closing torque to the drive spindle, wherein the drive spindle is also operably connected to a second spring configured to apply a second closing torque to the drive spindle, wherein the connection between the first spring and the drive spindle is independent from the connection between the second spring and the drive spindle, and wherein variation of the first closing torque as a function of drive spindle orientation is different from variation of the second closing torque as a function of drive spindle orientation. Using first and second springs to independently actuate the drive spindle allows a shorter transition to be achieved between a relatively low closing torque and a relatively high closing torque. The relatively high closing torque may be provided for example by the first spring and the second spring in combination, and the relatively low closing torque may be provided for example by the second spring alone.

The connection between the first spring and the drive spindle may comprise a first cam, the first cam being actuated by a first cam follower which is connected to the first spring, and the connection between the second spring and the drive spindle may comprise a second cam, the second cam being actuated by a second cam follower which is connected to the second spring.

The first cam may have a profile which is different from a profile of the second cam.

The first spring may be at least partially located within the second spring.

The first cam follower may be at least partially located within the second cam follower.

The first spring and the second springs may be substantially coaxial.

The first and second springs may have different stiffnesses. The stiffness of the first spring may be greater than the stiffness of the second spring.

The profile of one of the cams may be configured such that it does not actuate an associated spring during rotation of the drive spindle through a predetermined range of orientations of the drive spindle. The term ‘does not actuate’ may be interpreted as meaning that the cam does not actuate the associated spring to a significant degree.

The predetermined range of orientations of the drive spindle may comprise any angle greater than 20°.

The profile of the cam may be substantially circular but include a recess.

The profile of the cam may be configured such that the recess aligns with an associated cam follower and receives a roller of the cam follower when the drive spindle is oriented at an angle of 0°.

The profile of one of the cams may be configured such that it actuates an associated cam follower and associated spring throughout all orientations of the drive spindle which occur during normal operation of the door. The profile of the cam may include a recess which is configured such that the recess aligns with an associated cam follower and receives a roller of the cam follower when the drive spindle is oriented at an angle of 0°.

The drive spindle may further comprise a third cam which is located on an opposite side of the first cam from the second cam, the third cam being configured such that the first spring resiliently biases the first cam follower against the third cam.

The door closer may further comprise an adjustment mechanism configured to adjust the length of the first and second springs.

The drive spindle may be connected to a pivot arm which is received in a slider rail.

The door closer may be provided on or in a door, and the slider rail may be provided on a door frame.

According to a second aspect of the invention there is provided a door closer comprising a drive spindle which is connected via a first cam to a first spring configured to apply a first closing torque to the drive spindle via the first cam, wherein the drive spindle is connected via a second cam to a second spring configured to apply a second closing torque to the drive spindle via the second cam, and wherein the first and second cams have different profiles.

The second aspect of the invention may incorporate one or more features of other aspects of the invention.

According to a third aspect of the invention there is provided a door closer comprising a drive spindle which is connected via a first cam to a first spring configured to apply a first closing torque to the drive spindle via the first cam, wherein the drive spindle is connected via a second cam to a second spring configured to apply a second closing torque to the drive spindle via the second cam. and wherein the first spring is at least partially located within the second spring.

The third aspect of the invention may incorporate one or more features of other aspects of the invention.

### BRIEF DESCRIPTION OF THE DRAWINGS

Specific embodiments of the invention will now be described by way of example only with reference to the accompanying drawings, in which:

FIG. 1 shows in cross-section viewed from one side a door closer according to an embodiment of the invention;

FIG. 2 shows in perspective view the door closer of FIG. 1 together with a pivot arm and slider rail;

FIG. 3 shows enlarged cross-sectional views of an energy storage mechanism of the door closer of FIG. 1, viewed from one side, and viewed from above in two different planes;

FIG. 4 shows in cross section viewed from one side the door closer of FIG. 1 with a spring adjuster of the energy storage mechanism having been actuated;

FIG. 5 shows enlarged cross-sectional views of a damping mechanism of the door closer of FIG. 1, viewed from one side, and viewed from above in two different planes;

FIGS. 6 and 7 show cross-sectional views from above in two different planes of the door closer of FIG. 1, with a spindle of the door closer having been rotated by different amounts;

FIG. 8 is a graph which shows the opening and closing torques applied by the door closer to a door; and

FIG. 9 is a graph which shows the torques applied by springs to a spindle of the door closer and which also shows the length of the springs.

### DETAILED DESCRIPTION

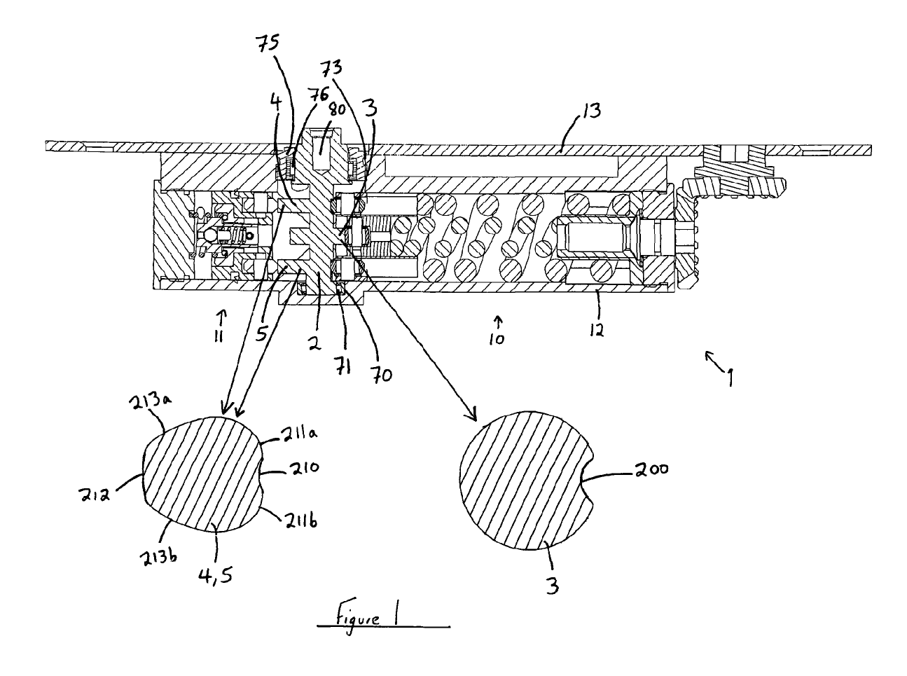

Referring to FIG. 1, a door closer 1 comprises an energy storage mechanism 10 and a damping mechanism 11, both of which are held in a housing 12. The energy storage mechanism 10 and the damping mechanism 11 are both operably connected to a drive spindle 2 which is held in the housing 12 but extends out of an upper surface of the housing.

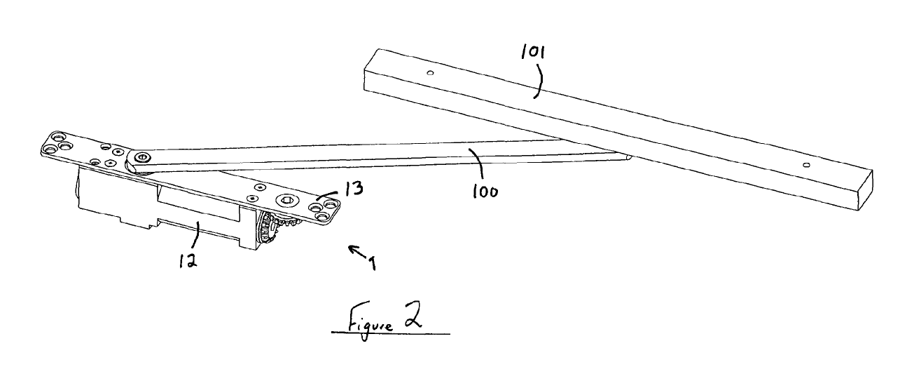

Referring to FIG. 2, the door closer 1 may be operably connected to a pivot arm 100, an opposite end of which is received in a slider rail 101. The pivot arm 100 is operably connected to the drive spindle 2 via a shaft which extends transverse to the pivot arm and is received in an opening provided at an upper end of the drive spindle. The connection between the pivot arm 100 and the drive spindle 2 is rigid, such that rotation of the pivot arm causes the drive spindle to rotate and vice versa.

The door closer may for example be provided in an uppermost portion of a door. A plate 13 to which the housing 12 is attached may for example be secured to an upper surface of a door (the housing being located within a recess in the door). In use, when the door is closed, the door closer is located beneath the slider rail 101. Opening the door causes the door closer to move away from the slider rail 101, thereby causing the pivot arm 100 and the drive spindle 2 to rotate. In tandem with this rotation, the end of the pivot arm 100 which is held in the slider rail 101 moves along the slider rail. Rotation of the drive spindle 2 during opening of the door transfers energy to the energy storage mechanism 10. When the door is released, this energy is transferred back from the energy storage mechanism 10 to the drive spindle 2, causing the drive spindle to rotate. The pivot arm 100 rotates with the drive spindle 2, thereby pulling the door towards the slider rail 101 (i.e. towards the closed position).

Referring again to FIG. 1, the drive spindle 2 is provided with three cams 3-5. The first cam 3 has a unique cam profile, which is shown in enlarged section viewed from above. The second and third cams 4,5 have the same cam profile, which is also shown in enlarged section viewed from above. The profiles of the cams 3-5 are such that they transform rotational motion of the drive spindle 2 into linear motion of springs in the energy storage mechanism 10, thereby allowing the springs to store energy when the door is opened. Similarly, the cam profiles 3-5 allow energy stored in the energy storage mechanism to be transformed into rotational motion of the drive spindle 2, thereby closing the door automatically.

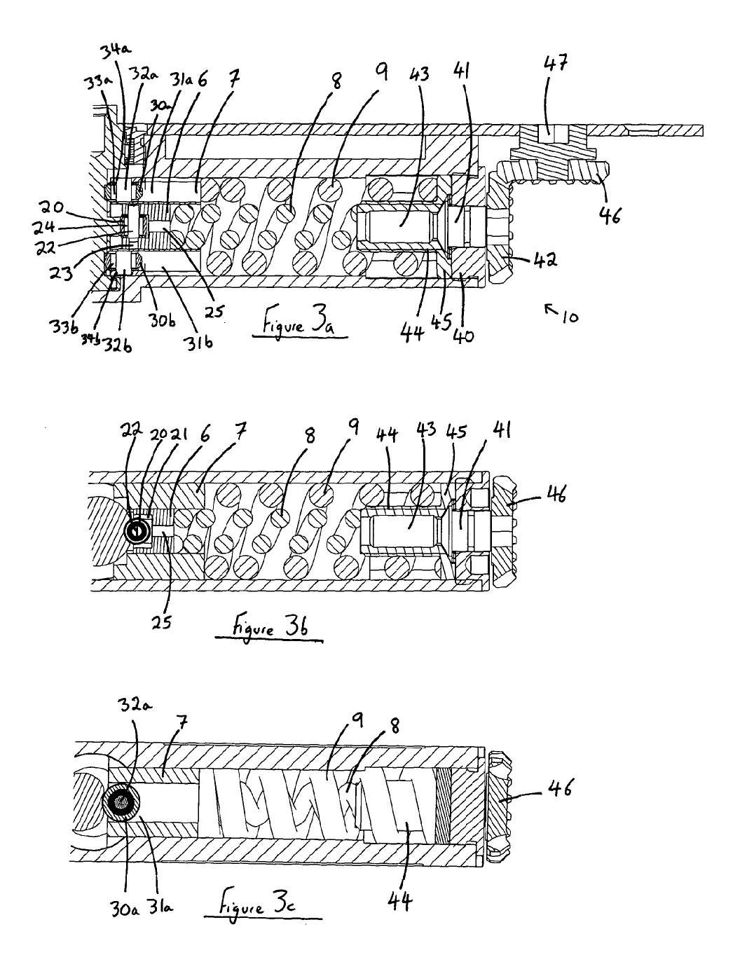

The energy storage mechanism 10 is shown in enlarged view in FIG. 3. FIG. 3a is cross-sectional view from one side of the energy storage mechanism, and FIGS. 3b and 3c are cross-sectional views from above of the energy storage mechanism in two different planes. The energy storage mechanism 10 comprises a first cam follower 6 and a first spring 8, and further comprises a second cam follower 7 and a second spring 9. The first spring 8 resiliently biases the first cam follower 6 against the first cam 3, and the second spring 9 resiliently biases the second cam follower 7 against the second and third cams 4,5. Both of the cam followers 6,7 are cylindrical. The second cam follower 7 is hollow, and the first cam follower 6 is located within the second cam follower. The first spring 8 is partially located within the second spring 9 (one end of the first spring projects beyond the second spring). The first and second springs 8,9 are coaxial. The stiffness of the first spring 8 is greater stiffness than the stiffness of the second spring 9. The first cam follower is 6 free to move in a longitudinal direction within the second cam follower 7. The first and second cam followers 6,7 are thus free to move independently of one another.

The first cam follower 6 is provided with a roller 20. The roller 20 is located within a cavity 21 formed in the first cam follower 6, the roller partially protruding from the cavity. The roller 20 is mounted on a pin 22 which is held in openings 23 provided in the first cam follower 6. A bearing 24 is provided between the roller 20 and the pin 22 to facilitate smooth rotation of the roller on the pin. Rotation of the drive spindle 2 causes, via the first cam 3, movement of the first cam follower 6 in the longitudinal direction. The roller 20 facilitates smooth movement of the first cam 3 relative to the first cam follower 6, and thereby facilitates the conversion of rotational movement of the drive spindle 2 to linear movement of the first cam follower.

The second cam follower 7 is provided with a pair of rollers 30a,b. Each roller 30a,b is located within a cavity 31a,b formed in the second cam follower 7, each roller partially protruding from the cavity. In this embodiment, each cavity 31a,b extends along the length of the second cam follower 7, although the cavities may be shorter in other embodiments. Each roller 30a,b is mounted on a respective pin 32a,b. Bearings 33a,b are provided between the rollers 30a,b and the pins 32a,b to facilitate smooth rotation of the rollers on the pins. The pins 32a,b are held in openings 34a,b formed in the second cam follower 7. The rollers 30a,b facilitate smooth movement of the second and third cams 4,5 relative to the second cam follower 7, and thereby facilitate the conversion of rotational movement of the drive spindle 2 to linear movement of the second cam follower.

A bore 25 passes through the centre of the first cam follower 6, allowing hydraulic fluid to pass from one side of the first cam follower to the other side of the first cam follower. This prevents the build up of hydraulic pressure on either side of the cam followers 6,7. Hydraulic fluid may in addition pass between the first cam follower 6 and the second cam follower 7, and may in addition pass between the second cam follower and the housing 12.

The housing 12 is closed at one end by a first end stop 40. The first end stop 40 is provided with a threaded outer surface which is received in a correspondingly threaded inner surface of the housing 12. A spring adjustment mechanism is provided at the first end stop 40. The spring adjustment mechanism comprises a rod 41 which passes through the first end stop 40. An outer end of the rod 41 is provided with a first bevelled gear 42 which is fixed to the rod such that rotating the bevelled gear will cause the rod to rotate. An opposite end of the rod 41 comprises a threaded portion 43 which is received in a correspondingly threaded collar 44. The collar 44 includes a flange 45 which receives the second spring 9. An end of the collar 44 which faces the first cam follower 6 receives the first spring 8. The first and second springs 8,9 are resiliently compressed between the collar 44 of the spring adjustment mechanism and the cam followers 6,7.

A second bevelled gear 46 is rotatably mounted to the plate 13 which is attached to the housing 12. The second bevelled gear 46 meshes with the first bevelled gear 42, such that rotating the second bevelled gear will cause the first bevelled gear to rotate. A shaft of the second bevelled gear 46, which extends through the plate 13, is provided with an opening 47 which is dimensioned to receive an Allen key. Rotation of an Allen key which is inserted into the opening 47 will cause the second bevelled gear 46 to rotate, and thereby cause the first bevelled gear 42 to rotate.

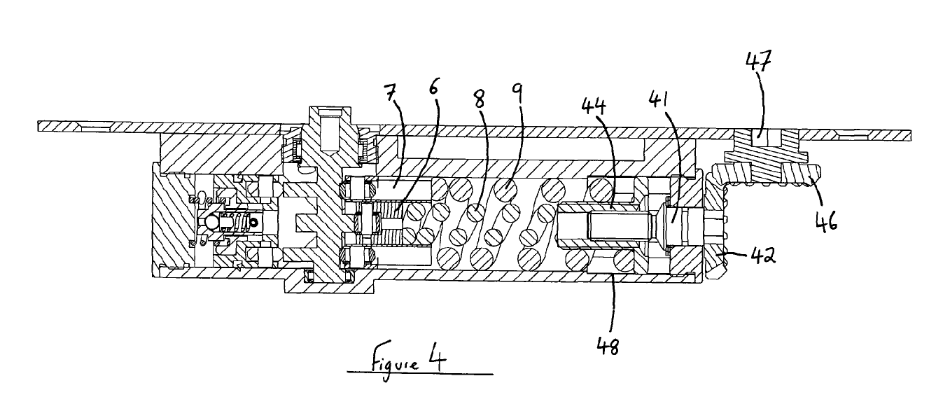

Rotation of the second bevelled gear, for example by rotation of an Allen key in the opening 47, will cause the first bevelled gear 42 and the rod 41 to rotate. The effect of this rotation is shown in FIG. 4, which shows the door closer 1 after rotation of the first bevelled gear 42. Rotation of the first bevelled gear 42 has caused the collar 44, via the screw-thread between the rod 41 and the collar 44, to move towards the first and second cam followers 6,7. This compresses the first and second springs 8,9, thereby increasing the energy stored in them. Rotation of the bevelled gears 42,46 in the opposite direction would cause the collar to move away from the first and second cam followers 6,7. This would allow the first and second springs 8,9 to expand, thereby reducing the energy stored within them. The collar 44 is prevented from rotating on the rod 41 by the housing 12, which has an inner surface 48 that is shaped to correspond to an outer surface of the collar. The inner surface 48 of the housing 12 and the outer surface of the collar 44 may for example both be hexagonal.

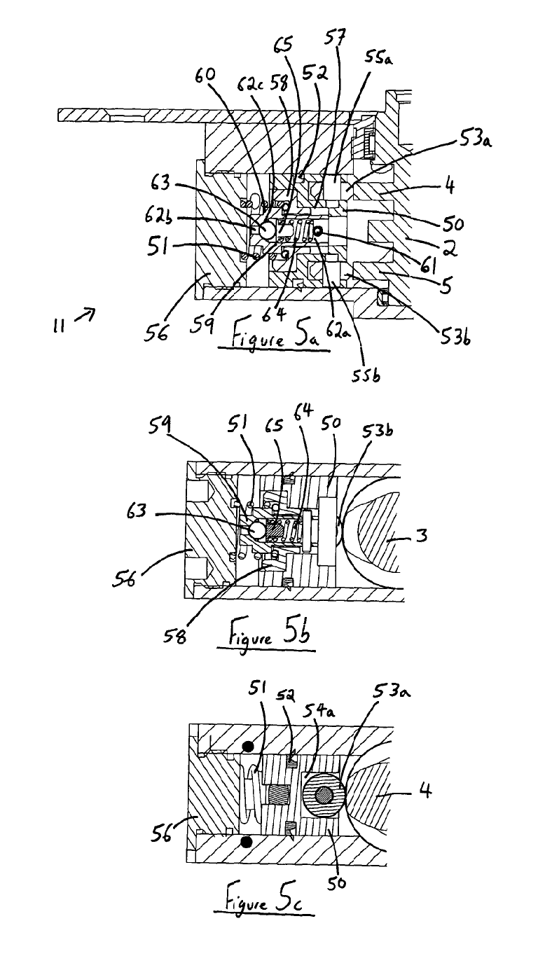

The damping mechanism 11 of the door closer is shown in more detail in FIG. 5. FIG. 5a is cross-sectional view from one side of the damping mechanism, and FIGS. 5b and 5c are cross-sectional views from above of the damping mechanism in two different planes. The damping mechanism 11 comprises a piston 50 which is resiliently biased against the second and third cams 4,5 by a spring 51. A ring seal 52 encircles the piston 50, thereby forming a seal against the housing 12 and preventing hydraulic fluid from passing between the piston 50 and the housing 12. First and second rollers 53a,b are located within cavities 54a,b formed in the piston 50, the rollers partially protruding from the cavities. The rollers 53a,b are mounted on pins 55a,b which are held in the piston 50. The spring 51 resiliently biases the piston 50 towards the drive spindle 2, such that the first and second rollers 53a,b press against the second and third cams 4,5.

The housing 12 is closed at a left hand end by a second end stop 56. The second end stop 56 is provided with a threaded outer surface which is received in a correspondingly threaded inner surface of the housing 12. The spring 51 is resiliently compressed between the end stop 56 and the piston 50.

The piston 50 includes a one way valve and a pressure relief valve. A stepped bore 57 is provided within the piston 50. A flanged collar 58 is located within the stepped bore 57, and a cylinder 59 is received within the flanged collar. The cylinder 59 includes a ridge 60 which may press against a seal provided in the flanged collar 58, thereby preventing the flow of hydraulic fluid between the cylinder 59 and the flanged collar. The cylinder 59 is capable of a small amount of lateral movement relative to the flanged collar 58, the lateral movement being restricted by a pin 61 which is held in bores provided in the cylinder 59. The pin 61 extends out of the cylinder 59, and restricts movement of the cylinder in the left hand direction by coming into contact with the flanged collar 58.

As mentioned further above, hydraulic fluid is provided within the housing 12. It is this hydraulic fluid which, together with movement of the piston 50, provides damping. When a door is being opened, the drive spindle 2 and the second and third cams 4,5 rotate. The profiles of the cams 4,5 are such that when they rotate they allow the piston 50 to move to the right (the piston is pushed in that direction by the spring 51). As the piston 50 moves to the right, the pressure of hydraulic fluid to the right hand side of the piston increases and the pressure of the hydraulic fluid to the left hand side of the piston decreases. This pressure differential pushes the cylinder 59 to the left, thereby introducing a gap between the ridge 60 of the cylinder and the flanged collar 58. Hydraulic fluid passes through this gap thereby equalising the pressure of the hydraulic fluid on either side of the piston 50.

When the door is being closed, rotation of the cams 4,5 pushes the piston 50 to the left. Movement of the piston 50 to the left is resisted by the hydraulic fluid. The hydraulic fluid cannot pass between the cylinder 59 and the flanged collar 58, since the cylinder is being pushed against the flanged collar, thereby sealing them together. Instead, the hydraulic fluid passes through regulator valves (not illustrated). The regulator valves allow the hydraulic fluid to flow at a regulated rate from the left hand side of the piston to the right hand side of the piston. It is this regulated flow of the hydraulic fluid which damps the closing movement of the door. The regulator valves may include adjustment mechanisms which allow the rate of flow of the hydraulic fluid to be controlled, thereby allowing the damping provided by the damping mechanism 11 to be controlled.

A pressure relief valve is also located within the piston 50. The pressure relief valve comprises a bore in the cylinder 59 which comprises a wide portion 62a and a narrow portion 62b, the wide portion and the narrow portion being connected by a tapered section 62c. A ball 63 is located in the wide portion 62a of the bore and is resiliently biased by a spring 64 such that it presses against the tapered section 62c of the bore, thereby sealing the bore. An end cap 65 is held by the spring, the end cap providing a surface which presses against the ball 63. An opposite end of the spring 64 presses against the pin 61 which is held in the cylinder 59.

The pressure relief valve isolates hydraulic fluid on the left hand side of the piston 50 from hydraulic fluid on the right hand side of the piston when the door is closing, unless the pressure of the hydraulic fluid on the left hand side of the piston exceeds a pre-determined threshold (the predetermined threshold being determined by the stiffness of the spring 64). When the pressure of the hydraulic fluid exceeds the pre-determined threshold {for example if the door is pushed towards the closed position with a large force), then the ball 63 will move towards the right within the bore 62. This introduces a gap between the ball 63 and the tapered section 62c of the bore, allowing hydraulic fluid to pass through the bore 62, and thereby equalising the pressure of the hydraulic fluid on either side of the piston 50.

Referring again to FIG. 1, the drive spindle 2 is held in a recess 70 formed in the housing 12. A ring bearing 71 is provided on the drive spindle 2, the bearing being received in the recess 70 of the housing, and allowing the drive spindle 2 to rotate freely within the housing 12.

An upper end of the drive spindle 2 passes out of an opening 73 of the housing 12. An annular cap 75 is provided between the drive spindle 2 and the housing 12. A ring bearing 76 is provided between the drive spindle 2 and the annular cap 75, thereby allowing the drive spindle to rotate freely within the annular cap. The annular cap 75 is provided with a threaded outer surface which is received in a correspondingly threaded inner surface of the opening 73 of the housing 12.

An opening 80 is provided at the upper end of the drive spindle 2. The opening 80 is generally rectangular in cross-section, includes a taper at a lowermost end, and has an upper portion with a widened diameter. An uppermost end of the opening 80 is counter-sunk. The opening 80 receives a shaft which extends transversely from the pivot arm 100 (see FIG. 2), thereby operably connecting the pivot arm to the drive spindle 2.

The perimeters of the cams 3-5 are selected to provide desired opening and closing torques when a door connected to the door closer is opened and closed. As can be seen from FIG. 1, the profile of the first cam 3 is generally circular, but includes a recess 200. In contrast to this, the second and third cams 4,5 have a more complex profile. This profile includes a recess 210 which is wider than the recess 200 of the first cam 3, and in addition includes bulges 211a,b which extend outwardly either side of the recess 210. An opposite side of the second and third cams 4,5 from the recess 210 does not include a recess, but instead is convex. This opposite side of the second and third cams 4,5 includes a central curved section 212 and outwardly tapering curved sections 213a,b.

FIGS. 1, 3 and 5 show the orientation of the drive spindle 2 and of the cams 3-5 when the door is closed. This orientation of the drive spindle 2 and the cams 3-5 is referred to hereafter as the closed orientation. As can be seen from FIG. 3b, the roller 20 of the first cam follower 6 is located in the recess 200 of the first cam 3. Similarly, the rollers 30a,b of the second cam follower 7 are located in respective recesses 210 of the second and third cams 4,5 (the uppermost of which is visible in FIG. 3c). As can be seen in FIG. 5c, the roller 53a of the damping piston 50 presses against the central curved section 212 of the second and third cams 4,5.

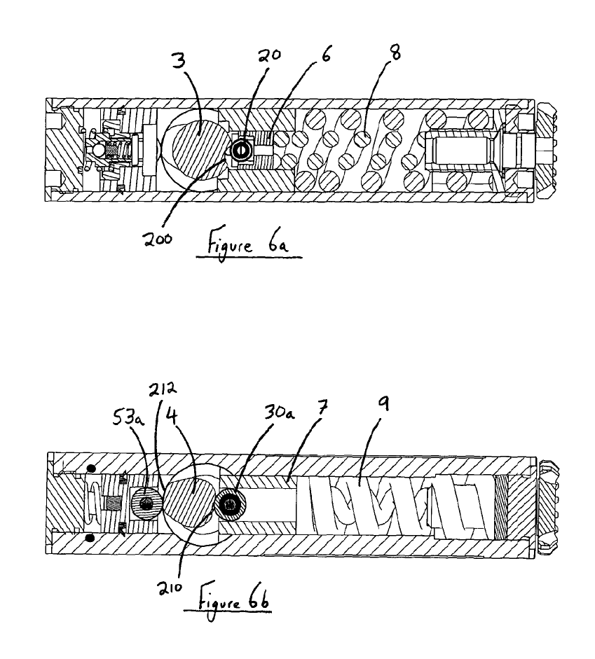

FIG. 6 shows in cross-section viewed from above in two different planes the door closer when the drive spindle 2 has been rotated by around 10° from the closed orientation. This may correspond to opening a door connected to the door closer by a little less than 10° (this depends on the geometry of the connection between the door and an associated door frame). Referring to FIG. 6a, rotation of the first cam 3 has pushed the roller 20 partially out of the recess 200, thereby compressing the first spring 8 via the first cam follower 6. Referring to FIG. 6b, the rotation of the second cam 4 and the third cam (not visible) has pushed the roller 30a and the roller 30b (not visible) of the second cam follower 7 partially out of the recess 210, thereby compressing the second spring 9. The movement of the first cam follower 6 is significantly greater than the movement of the second cam follower 7, the first cam follower moving within the second cam follower. The compression of the first spring 8 is significantly greater than the compression of the second spring 9. The combined compressions of the first and second springs 8,9 give rise to a relatively high torque when moving the door from a closed position to a slightly open position (in this case an open angle of a little less than 10°). Similarly, the combined compressions of the first and second springs 8,9 give rise to a relatively high closing torque when the door is moving from a slightly open position (in this case an open angle of a little less than 10°) to a closed position. This helps to ensure that the door closes and latches properly.

Referring again to FIG. 6b, the roller 53a of the damping piston 50 has moved slightly to the right, due to the rotation of the second cam 4 and the third cam (not visible), and the spring 51 has expanded slightly.

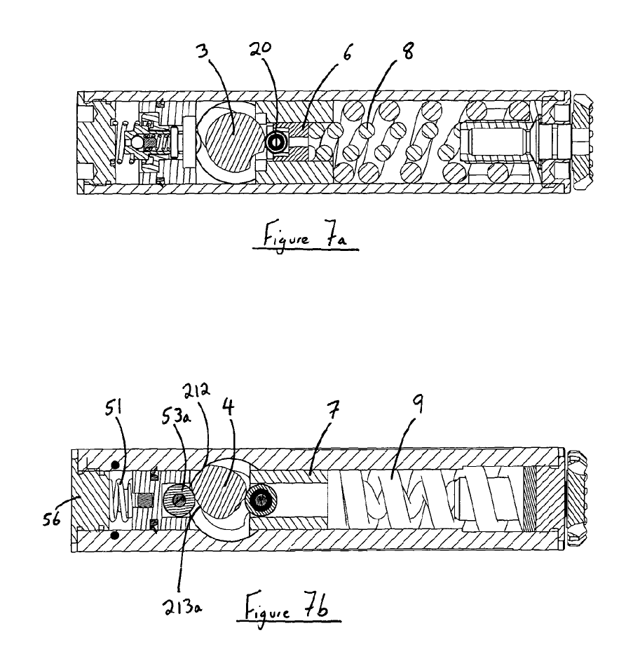

FIG. 7 shows in cross-section viewed from above in two different planes the door closer when the drive spindle 2 has been rotated by around 45° from the closed orientation. This may correspond to opening a door connected to the door closer by a little less than 45° (depending on the geometry of the connection between the door and the door frame). Referring first to FIG. 7a, the roller 20 of the first cam follower 6 rests against a circular portion of the perimeter of the first cam 3. Consequently, rotation of the first cam 3 does not cause further compression of the first spring 8. Thus, the first spring 8 offers no resistance to further opening of the door, and does not store any energy during further opening of the door. As can be seen from FIG. 7a, once the roller 20 of the first cam follower 6 has fully exited the recess 200 of the first cam 3, further rotation of the drive spindle 2 does not cause further movement of the first cam follower 6. Thus, once the drive spindle 2 has been rotated beyond an angle which corresponds to the end of the recess 200, the first spring 8 offers no further resistance to opening of the door. Similarly, during automatic door closure the first spring 8 applies no closing torque to the drive spindle 2 until the roller 20 of the first cam follower begins to enter the recess 200 of the first cam.

The first cam 3, first cam follower 6 and first spring 8 provide a closing torque when the door is moving from a slightly open position to a closed position, and no closing torque when the door is moving from a fully open position to a slightly open position. In addition, the transition from applying no closing torque to applying a closing torque takes place rapidly, as the roller 20 of the first cam follower begins to enter the recess 200. The transition from applying no closing torque to applying a closing torque may take place for example during rotation of the drive spindle through a range of angles which is less than 20°, less than 15° or less than 10°.

Referring to FIG. 7b, the second cam follower 7 has been pushed further to the right by the second cam 4 and the third cam (not visible), thereby causing further compression of the second spring 9. It is the second spring 9 which thus provides resistance to further opening of the door, and which stores energy during further opening of the door. As may be determined from consideration of the profile of the second and third cams 4,5, further opening of the door will continue to cause further movement of the second cam follower 7 to the right, and thus cause further compression of the second spring 9. The second and third cams 4,5, second cam follower 7 and second spring 9 thus continue to provide closing torque for further opening angles of the door.

Referring again to FIG. 7b, the damping piston 50 can be seen to have moved further to the right. The upper roller 53a is in contact with the outwardly tapering curve 213a of the second cam 4. As may be determined from consideration of the profile of the second and third cams, further opening of the door will cause the damping piston 50 to move further to the right. Movement of the damping cam follower to the right expands a volume between the piston 50 and the second end cap 56. Hydraulic fluid which flows into this expanded volume will provide damping when the door subsequently closes.

When the door is released, the energy stored in the first and second springs 8,9 causes the door to close automatically. Referring first to FIG. 7, if the door is released when the angle of drive spindle 2 rotation is around 45°, then the first spring 8 does not provide closing torque since the first cam follower 6 is in contact with a circular portion of the first cam 3. Closing torque is thus exclusively provided by the second spring 9 via the second and third cams 4,5. This closing torque may be relatively low. Referring to FIG. 6, if the door has an angle of drive spindle 2 rotation of around 10°, then both the first and second springs 8,9 apply closing torque to the drive spindle (and hence to the door). The closing torque which is applied is thus relatively high, thereby helping to ensure that the door closes and latches properly.

Closure of the door is damped via the flow of hydraulic fluid through regulator valves (not illustrated) driven by movement of the damping piston 50 towards the second end stop 56. This limits the speed at which the door moves towards the closed position.

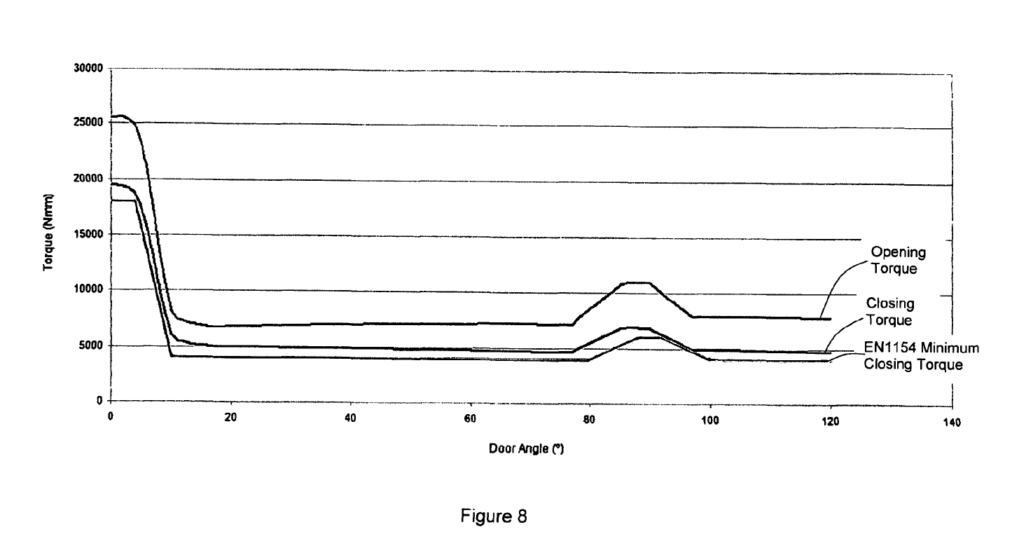

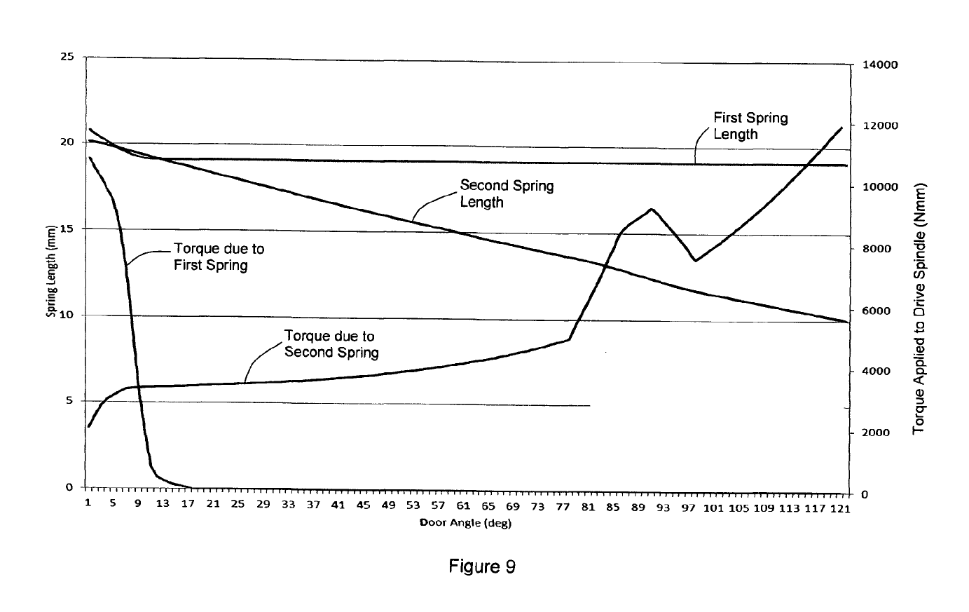

As explained above, due to the profiles of the cams 3-5, the closing torque when the door is moving from a partially open position to a closed position (e.g. between 10° and 0°) is higher than the closing torque when the door is moving between more open positions (e.g. between 120° and 20°). The opening torque and closing torque applied to the door by the door closer are shown as a function of door opening angle in FIG. 8. The torque applied to the drive spindle 2 by the springs 8,9 and cams 3-5 as a function of door opening angle is shown in FIG. 9 together with the lengths of the springs. The torque at the drive spindle 2 does not correspond exactly with the torque applied to the door due to the effect of the geometry of the pivot arm 100 and slider rail 101.

Referring first to FIG. 9, it may be seen that the torque at the drive spindle 2 due to the first spring 8 and first cam 3 is high when the door is closed and at small opening angles of the door (e.g. from zero to around 6°). The torque due to the first spring 8 and first cam 3 drops rapidly as the opening angle of the door increases to around 100, then drops more slowly to zero (reaching zero by around 17°). The length of the first spring 8 reduces at a relatively constant rate as the opening angle of the door is increased until the opening angle of the door reaches around 17°, after which the length of the first spring remains constant.

The torque at the drive spindle 2 due to the second spring 9 and second and third cams 4,5 is low when the door is closed and remains low though rising at a relatively rapid rate for small opening angles of the door (e.g. from zero to around 10°). The torque due to the second spring 8 and second and third cams 4,5 then rises gradually as the opening angle of the door increases to around 80°. Beyond 80° the underlying torque continues to increase, the rate of increase rising gradually as the door reaches a maximum opening angle of 120°. The length of the second spring 9 increases linearly across the full range of opening angles of the door (i.e. between 0 and 120°).

Superimposed onto the increasing underlying torque generated by the second spring 9 and second and third cams 4,5 is a peak which has a maximum at around 90°. This peak arises from the profile of the second and third cams 4,5, and acts to bias the door to an opening angle of 90° if the door has an opening angle in the range around 80-110°.

FIG. 8 shows the opening and closing torques applied to the door by the door closer. FIG. 8 thus illustrates the net effect of the torques applied by the springs 8,g and the cams 3-5 to the spindle 2, together with the effect of the geometry of the pivot arm 100 and slider rail 101. The opening torque and the closing torque both have the same shape as a function of the opening angle of the door. However, the magnitude of the closing torque is lower than the magnitude of the opening torque due to the efficiency of the door closer being less than 100% (the efficiency may for example be around 66%).

At door opening angles greater than around 17° the first spring 8 applies no torque to the drive door, and the torque shown in FIG. 8 is therefore applied exclusively by the second spring 9 in combination with the second and third cams 4,5. The geometry of the pivot arm 100 and slider rail 101 is such that the gradually increasing torque applied to the drive spindle 2 by the second spring 9 and second and third cams 4,5 is converted to a substantially constant torque applied to the door. A peak of torque which is substantially centred at an opening angle of around 90° may be seen in FIG. 8, the location of the peak corresponding to that shown in FIG. 9.

At door opening angles less than around 17° the torque applied to the door is the sum of the torque applied by the first spring 8 and first cam 3 and the torque applied by the second spring 9 and the second and third cams 4,S. Referring again to FIG. 9 it may be seen that for door opening angles of less than around so the torque applied to the drive spindle 2 by the first spring 8 drops relatively rapidly whilst at the same time the torque applied to the drive spindle by the second spring 9 rises relatively rapidly. As may be seen from FIG. 8, the sum of the dropping and rising torques is a relatively constant torque applied to the door for door opening angles of less than around so. As the door opening angle is increased beyond around so the sum of the torques applied by the first and second springs 8,9 drops, due primarily to a reduction in the torque applied by the first spring 8. The rate at which the torque applied to the door reduces remains relatively constant for door opening angles up to around 10°. The torque then reduces more gradually until a constant torque is reached at a door opening angle of around 17°.

As will be appreciated from FIGS. 8 and 9 the torque which is applied to the door by the first spring 8 and the first cam 3 is greater than the closing torque which is applied to the door by the second spring 9 and the second and third cams 4,S and the second spring 9. This may be achieved through the first spring 8 having a greater stiffness than the second spring 9. The first spring 8 may for example be around 30% stiffer than the second spring 9.

FIG. 8 also shows the minimum door closing torque as a function of door angle which is required by British Standard EN 11S4. As may be seen from FIG. 8, the door closing torque generated by the door closer described above exceeds the minimum required door closing torque for all angles of the door.

The British Standard EN 1154 includes the requirement that the door closing torque at small angles (Jess than around 10°) is high, and allows the door closing torque to be considerably lower at greater angles. This requirement may be considered to be a desirable characteristic of a door closer. In addition, it may be considered to be desirable that the transition from relatively high torque to relatively low torque is short (as a function of door angle), so that opening the door does not require a large amount of effort for a large range of door angles. Using first and second springs 8,9 independently to actuate the drive spindle 2 allows a shorter transition to be achieved between a relatively high closing torque at small angles and a relatively low closing torque at greater angles (compared with the transition if a single spring were to be used). The relatively high closing torque may be provided for example by the first spring 8 and the second spring 9 in combination, and the relatively low closing torque may be provided for example by the second spring alone. Alternatively, the relatively high closing torque may be provided for example by the first spring 8 and the second spring 9 in combination, with a majority of the relatively low closing torque being provided by the second spring and a minority of the relatively low closing torque being provided by the first spring (or vice versa).

Although the first spring 8 is shown as being at least partially located within the second spring 9, in an embodiment the first spring may instead be provided next to the second spring. However, providing the first spring 8 at least partially within the second spring 9 is advantageous because it allows two independently operable springs to be used in the door closer without increasing the volume of the door closer beyond that which would be required in order to accommodate the second spring. This configuration of the first and second springs 8,9 which may be considered to be telescopic, thus provides a significant advantage over prior art door closers.

Although the first and second springs 8,9 are shown as being helical, they may have any suitable shape. For example, the first and second springs may be rectangular wire springs (i.e. rectangular in cross-section). Although the first and second springs are shown as being coaxial 8,9, they may be provided in an arrangement that is not coaxial (for example, their axes may be offset).

In the described embodiment the stiffness of the first spring 8 is greater than the stiffness of the second spring 9. In an alternative embodiment however, the stiffness of the second spring 9 may be greater than the stiffness of the first spring 8.

The first and second cam followers 6,7 described above are cylindrical, and to some extent resemble pistons. However, the first and second cam followers 6,7 may have any suitable shape. Although the first cam follower 6 is provided within the second cam follower 7, other cam follower configurations may be used. For example, the first and second cam followers may each be semicircular in cross-section and may be positioned such that flat surfaces of the cam followers are adjacent to one another. This may however cause the springs 8,9 to be asymmetrically loaded, and for this reason it may be preferred to provide the first cam follower within the second cam follower.

Although the spring adjustment mechanism is shown as being driven by a pair of bevelled gears 42,46, any other suitable means may be used to drive the spring adjustment mechanism. The spring adjustment mechanism itself may have any suitable form.

Although the second cam follower 7 is driven by a pair of cams 4,5, in an alterative arrangement the second cam follower may be driven by a single cam. Similarly, although the first cam follower 6 is driven by a single cam 3, it may be driven by a pair of cams. The first and second cam followers 6,7 may each be driven by any suitable number of cams. The cams 3-5 may be provided with any suitable profiles.

Although the cam followers 6,7 are provided with rollers 20, 30a,b, the rollers are not essential and may be omitted or replaced with some other suitable apparatus.

The profile of the first cam 3 has been described as being generally circular but including a recess 200. As a result of this profile, once the drive spindle 2 has been rotated beyond an angle which corresponds to the end of the recess 200, the first spring 8 offers no further resistance to opening of the door. In an embodiment, the profile of the first cam 3 may include a recess at a position which corresponds to the door being open at 90°, the recess being configured such that the drive spindle 2 holds the door open without the application of external force.

The profile of the first cam 3 is such that it does not actuate the first spring 8 during rotation of the drive spindle 2 through a predetermined range of opening angles of the door (or does not actuate the first spring 8 to a significant extent). A lower limit of the predetermined range of opening angles of the door may for example be 20°, may be 15°, or may be 10°. In an embodiment there may be no upper limit of the predetermined range of opening angles of the door. In an alternative embodiment, an upper limit of the predetermined range of opening angles of the door may for example be 75°, may be 80°, or may be 85°.

In alternative embodiments of the invention, the first cam 3 may have some other profile. For example, the first cam 3 may be generally circular but may include more than one recess. For example, the first cam 3 may deviate from being generally circular such that it applies a limited force to the door over some or all opening angles of the door in excess of for example 20°. The limited force applied to the door by the first cam 3 may be substantially less than the force applied to the door by the second and third cams 4,5 over some or all opening angles of the door in excess of for example 20°.

In an alternative embodiment of the invention, the first cam 3 may be provided with a profile which provides closing torque over all opening angles of the door, and the second and third cams 4,5 may be provided with profiles which only provide significant closing torque for small opening angles of the door.

The door closer may be provided with a third cam follower, together with an associated spring and one or more cams. The third cam follower may for example allow a more complex relationship to be defined between the torque of the door closer and the orientation of the drive spindle. This may be achieved by providing the one or more cams with profiles that differ from the profiles of the first, second and third cams 3-5. Any suitable number of cam followers, associated springs and cams may be provided in the door closer.

The cams may be replaced with a rack and pinion arrangement. For example, two different racks may be driven by the same pinion, which may correspond with the drive spindle. Each rack may be connected to a different spring, the springs being arranged to provide different closing torques to the door.

The door closer may be fitted in a recess in a door, or may be attached to a side of the door. In an alternative arrangement, the door closer may be fitted in a recess in a door frame, or may be attached to a door frame. Where this is the case, a slider rail may be provided on the door.

FIG. 2 and associated description refers to connecting the door closer to a door and door frame via a pivot arm and slider rail. It will be appreciated however that the door closer may be connected to a door and door frame using any suitable apparatus.

What is claimed is:

1. A door closer comprising a drive spindle which is operably connected to a first spring configured to apply a first closing torque to the drive spindle, wherein the drive spindle is also operably connected to a second spring configured to apply a second closing torque to the drive spindle, wherein the connection between the first spring and the drive spindle is independent from the connection between the second spring and the drive spindle, and wherein variation of the first closing torque as a function of drive spindle orientation is different from variation of the second closing torque as a function of drive spindle orientation.

2. The door closer of claim 1, wherein the connection between the first spring and the drive spindle comprises a first cam, the first cam being actuated by a first cam follower which is connected to the first spring, and the connection between the second spring and the drive spindle comprises a second cam, the second cam being actuated by a second cam follower which is connected to the second spring.

3. The door closer of claim 2, wherein the first cam has a profile which is different from a profile of the second cam.

4. The door closer of claim 2, wherein the first cam follower is at least partially located within the second cam follower.

5. The door closer of claim 1, wherein the first spring is at least partially located within the second spring.

6. The door closer of claim 1, wherein the first and second springs are substantially coaxial.

7. The door closer of claim 1, wherein the first and second springs have different stiffnesses.

8. The door closer of claim 2, wherein the profile of one of the cams is configured such that it does not actuate an associated spring during rotation of the drive spindle through a predetermined range of orientations of the drive spindle.

9. The door closer of claim 8, wherein the predetermined range of orientations of the drive spindle comprises any angle greater than 20°.

10. The door closer of claim 8 wherein the profile of the cam is substantially circular but includes a recess.

11. The door closer of claim 10, wherein the profile of the cam is configured such that the recess aligns with an associated cam follower and receives a roller of the cam follower when the drive spindle is oriented at an angle of 00.

12. The door closer of claim 2, wherein the profile of one of the cams is configured such that it actuates an associated cam follower and associated spring throughout substantially all orientations of the drive spindle which occur during normal operation of the door.

13. The door closer of claim 12, wherein the profile of the cam includes a recess which is configured such that the recess aligns with an associated cam follower and receives a roller of the cam follower when the drive spindle is oriented at an angle of 00.

14. The door closer of claim 2, wherein the drive spindle further comprises a third cam which is located on an opposite side of the first cam from the second cam, the third cam being configured such that the first spring resiliently biases the first cam follower against the third cam.

15. The door closer of claim 1, further comprising an adjustment mechanism configured to adjust the length of the first and/or second spring.

16. The door closer of claim 1, wherein the drive spindle is connected to a pivot arm which is received in a slider rail.

17. The door closer of claim 16, wherein the door closer is provided on or in a door, and the slider rail is provided on a door frame.

18. A door closer comprising a drive spindle which is connected via a first cam to a first spring configured to apply a first closing torque to the drive spindle via the first cam, wherein the drive spindle is connected via a second cam to a second spring configured to apply a second closing torque to the drive spindle via the second cam, wherein the first and second cams have different profiles.

19. A door closer comprising a drive spindle which is connected via a first cam to a first spring configured to apply a first closing torque to the drive spindle via the first cam, wherein the drive spindle is connected via a second cam to a second spring configured to apply a second closing torque to the drive spindle via the second cam, wherein the first spring is at least partially located within the second spring.
